(19) United States
(12) Patent Application Publication
(10) Pub. No.: US 2020/0251972 A1
(43) Pub. Date: Aug. 6, 2020

(54) ELECTRICAL PUMP DRIVE FOR A POSITIVE DISPLACEMENT PUMP, POSITIVE DISPLACEMENT PUMP AND METHOD THEREFOR

(71) Applicant: NIDEC GPM GmbH, Merbelsrod (DE)

(72) Inventors: Conrad NICKEL, Troistedt (DE); Franz PAWELLEK, Lautertal (DE)

(21) Appl. No.: 16/648,845

(22) PCT Filed: Jul. 12, 2018
(86) PCT No.: PCT/EP2018/068981

§ 371 Date: Mar. 19, 2020

(30) Foreign Application Priority Data
Sep. 28, 2017 (DE) 10 2017 122 613.3

(51) Int. Cl. H02K 33/12; F04B 17/04

(52) U.S. Cl. CPC H02K 33/12; H02K 33/02; F04B 17/042

(57) ABSTRACT

An electrical pump drive for positive displacement pumps having pistons moved in an oscillating manner. The electrical pump drive has a rotary magnet which has at least one electromagnet and an armature which can swivel about an axis and which is pivotable alternately between two working points by means of excitation of the at least one electromagnet. The armature is configured for coupling to a piston which is moved in an oscillating manner.

### BACKGROUND OF THE INVENTION

The invention relates to an electrical pump drive for displacement pumps with pistons moved in an oscillating manner, a displacement pump with said pistons and a corresponding method for moving a piston of a displacement pump in an oscillating manner.

Known from the prior art are displacement pumps, compressors and vacuum pumps which, in contrast to a kind of rotary displacement pump such as a vane pump, perform a discontinuous movement of the pump components, in particular a reciprocating movement thereof. Such displacement pumps drive displacement pistons which oscillate between two turning points and thereby perform work cycles in which a load change of an incoming and outgoing conveyed medium in a pump chamber is effected.

Among these, so-called double-action pumps are known, which simultaneously produce two opposing load changes in the pump chamber in both directions of movement of a piston, i.e. an inflow on one side of the piston and an outflow on the other side of the piston. Furthermore, such displacement pumps are distinguished by various amplitudes, in particular linear and arc-shaped amplitudes, of the oscillating piston motion.

According to the technical teaching in the prior art to date, parts in displacement pumps that are moved in an oscillating manner are exclusively driven by rotating electrical machines in the known designs of electric motors or by other mechanical drive sources with a rotating drive shaft, which are coupled by way of belt or gear transmission, for example. Moreover, a mechanical adjusting mechanism is always coupled between a pump assembly and a drive shaft, which creates an eccentric linkage of the moving parts relative to the drive shaft by means of a connecting rod, a crank pin and an elongate hole, a cam mechanism with cams, a control cam or the like.

In general, the kinematics of such a mechanism consists in converting the rotatory drive movement into a linear or reciprocating movement in the direction of the operating path of the piston. This results in an imbalanced dynamic, which means that dead centres have to be overcome in order to convert a rotatory continuous force into alternately accelerating forces.

In practice, this dynamic imbalance has a number of disadvantages. For example, when starting a displacement pump a high drive torque is required for overcoming the first dead centre. This is particularly true in the case of a cold start of a system in which a medium with a temperature-sensitive viscosity, such as a lubricating oil, for example, is conveyed. To ensure operability, this has the economic disadvantage that a drive must be provided which is relatively large in relation to the nominal output thereof. Furthermore, an eccentric adjusting mechanism must also in principle be provided, which must be designed to meet requirements in terms of wear resistance, space and cost, depending on the field of application of the pump. Based on this assessment, there is therefore room for improvement in various aspects.

### BRIEF SUMMARY OF THE INVENTION

The present invention is based on the object of creating an alternative pump drive for displacement pumps with pistons moved in an oscillating manner.

According to the invention, the object is achieved by the features of the electrical pump drive according to claim 1, the displacement pump according to claim 15 and the method according to claim 17.

In particular, the electrical pump drive according to the invention is characterised in that it comprises a rotary solenoid which has at least one electromagnet and an armature that can be pivoted about an axis and can be pivoted alternately between two working points by exciting the at least one electromagnet, wherein the armature is adapted to couple with a piston moved in an oscillating manner.

Accordingly, the displacement pump with a piston moved in an oscillating manner between two turning points as according to the invention is characterised in particular in that an electrical pump drive comprises a rotary solenoid which has at least one electromagnet and an armature that can be pivoted about an axis, which armature can be pivoted alternately between two working points by exciting the at least one electromagnet, wherein the armature is coupled with the piston such that the turning points of the oscillating motion of the piston are reached at the working points of the armature.

Similarly, the method for moving a piston of a displacement pump in an oscillating manner between two turning points by means of a rotary solenoid as according to the invention is characterised by the steps of: generating a magnetic field by means of an electromagnet, which exerts a torque upon the armature in a pivoting direction until the piston reaches a turning point; and interrupting the generation of the magnetic field by the electromagnet and/or generating a magnetic field of opposite polarity by means of an electromagnet, which exerts a torque upon the armature in the opposite pivoting direction until the piston reaches the other turning point.

The invention therefore proposes for the first time using a rotary solenoid as a drive source of a pump drive for a non-rotary displacement pump.

In its most general form, the present invention is based on the finding that a pump drive optimised for the alternating acceleration of a displacement piston ideally already electrodynamically generates a similarly reciprocally alternating torque with an intensity in the form of amplitudes. According to the invention, such a demand-oriented torque that is suitable in terms of both its dynamic intensity and its kinematic alignment is provided by a rotary solenoid. This constitutes a fundamental departure from the drive concept of a continuous torque of a rotary drive force and a kinematic conversion of the drive movement.

In the context of the present disclosure, rotary solenoids differ by definition from rotating electrical machines in particular in that the movement that can be performed by the armature of a rotary solenoid is limited to an angle of rotation between two working points, i.e. it cannot perform a complete turn. In contrast to the stator of an electric motor with a plurality of excitation coils for generating a rotary magnetic field, the rotary solenoid is merely equipped with one or two electromagnets depending on the design thereof. In special forms for particularly high-torque designs, the rotary solenoid can have a symmetrical arrangement of 4 or 6 electromagnets, as a result of which the angle of rotation that can be achieved is geometrically reduced to a fraction of the factor.

Rotary solenoids, which are also referred to as rotary magnets, are actuators which are known from the field of plant engineering and construction, for example, for operating a switch in a conveying section or a so-called shutter such as a deflecting plate in a sorting section between two positions of a fork or junction.

In general, a distinction is made between proportional rotary solenoids or rotary magnets with a return spring and bistable rotary solenoids having an electromagnet with alternately reversed polarity or two alternately excited electromagnets. Analogous to the design of an electric motor, a power transmission can be established by a polarity between the permanent magnet of the armature and the stationary electromagnet, or the reluctance principle between armature poles and pole shoes of a magnetic circuit of a stationary electromagnet, such as by a pole ring, for example. Known rotary solenoids also differ in their design, for example by a radial or axial arrangement between the armature and the electromagnet, as a result of which a torque of a rotatory relative movement is generated, or an axial arrangement with wedge-shaped grooves or surfaces and rolling elements between the armature and electromagnet, as a result of which an axially generated torque is converted into a helix-shaped relative movement. These different types and designs of rotary magnets or rotary solenoids, and other known types and designs thereof, are to be understood in the context of the present disclosure under the collective designation of a rotary solenoid and are suitable for carrying out the invention as well as being optionally provided therefor.

To improve an electrical pump drive for displacement pumps in view of the disadvantages mentioned with respect to the prior art as well as in other aspects, the invention provides numerous advantages which will be set out in the following.

With a rotary solenoid, the magnetic force can be increased by temporarily over-exciting the electromagnet, as a consequence of which very high torques are achieved. With a suitable control, there is a high torque particularly at the beginning of a pivoting motion of the armature from one working point to another, which decreases as it approaches the other working point, as a result of which it is possible to cover the torque requirement of an oscillating acceleration. Moreover, a rotary solenoid offers fast reaction times and remains in the end position of a working point without energisation. As a result, energy consumption and heat loss are reduced.

Compared with an electric motor, a rotary solenoid having the same dimensions achieves a larger excitation coil winding and therefore a higher power consumption or a higher electrodynamic force within the sphere of action of the coil, i.e. the working section of the armature, which meets the cold-start requirement of various applications. At the same time, the number of coils, wires, poles and other structural elements is smaller, and therefore a more compact, highly-integrated construction with just a few individual parts and lower production costs is realised.

Compared with brushless direct current motors, which require a relatively complex ECU and power electronics, the technical requirements of the control of the rotary solenoid allow simplifications and cost savings in terms of the wiring of the power supply.

Moreover, depending on the type of pump assembly the costs incurred and the need for space for a mechanism as well as the risk of wear and tear thereof are completely eliminated or reduced.

Advantageous embodiments of the present invention are described in the dependent claims.

According to one aspect of the invention, an electromagnet of the rotary solenoid is able to be excited by an alternating current polarity for the alternating pivoting motion of the armature. In this case the change in direction of the armature is implemented purely by means of control technology.

Thus, a simple construction of the rotary solenoid with just a few electrical components is achieved, as a result of which the provision of an inexpensive electrical pump drive of a displacement pump is made possible.

According to one aspect of the invention, the rotary solenoid can further comprise a return spring for the armature, and the electromagnet is able to be excited for the pivoting motion of the armature against a restoring force of the return spring. In this case a change in direction of the rotary solenoid is implemented merely by switching the power supply on and off.

Thus, a simple construction of the control wiring is achieved, as a result of which the provision of an inexpensive control of the electrical pump drive of a displacement pump is made possible.

According to one aspect of the invention, the rotary solenoid can have at least two electromagnets, wherein the at least two electromagnets are able to be excited alternately for the alternating pivoting motion of the armature.

A power loss as a result of reversing the polarity of an individual electromagnet and corresponding heat generation are therefore prevented. Furthermore, heat generation is further reduced by dividing the energisation or power supply between two electromagnets as separate components.

According to one aspect of the invention, the armature of the rotary solenoid can comprise at least one permanent magnet. A pivoting motion of the armature from one working point to another working point follows a repulsive and/or attractive force of the magnetic polarity between the permanent magnet and the electromagnet.

Thus, a structurally simple construction of the rotary solenoid is provided, which achieves a high torque at the armature by way of magnetic forces between the magnetic poles. This enables the provision of an electrical pump drive for displacement pumps with a good ratio of high performance to compact dimensions.

According to one aspect of the invention, the armature of the rotary solenoid can comprise a ferromagnetic armature body with pronounced armature poles, and the armature poles are assigned to pole shoes disposed stationarily at a working point of the armature. A pivoting motion of the armature from one working point to another working point follows the reluctance force so that the smallest air gap in the magnetic circuit of an electromagnet is formed.

Thus, a construction of the rotary solenoid without permanent magnets is achieved, which has an advantageous power consumption profile in the partial load range comparable to a reluctance motor. As a result, an inexpensive electrical pump drive for displacement pumps without the use of rare earth for permanent magnetic alloys is provided. Furthermore, the alignment of a magnetic circuit by means of the pole shoes also allows the angle of rotation of the rotary solenoid to be defined.

According to one aspect of the invention, the armature of the rotary solenoid can comprise an armature body with ferromagnetic armature poles which have greater magnetic permeability than other sections of the armature body, and the armature poles are assigned to pole shoes disposed stationarily at a working point of the armature. A pivoting motion of the armature from one working point to another working point follows the reluctance force so that the armature body encounters the least magnetic reluctance in the magnetic circuit of an electromagnet.

Thus, an alternative construction of the rotary solenoid having the aforementioned advantages of the reluctance principle is provided as an inexpensive electrical pump drive for displacement pumps without the use of rare earth.

According to one aspect of the invention, the rotary solenoid can comprise limitation means which limit a pivoting motion of the armature at the two working points.

The working points of any rotary solenoid, in particular any rotary solenoid with permanent magnets, can therefore be specified more accurately. Moreover, if desired for the specific application, a short-term holding torque can be generated against such a mechanical stop. In contrast, if desired for the specific application, a rebound of the armature at the mechanical stop can also be generated, which can occur before the piston abuts against a chamber wall in the pump assembly.

According to one aspect of the invention, the electromagnet and the armature can be arranged in such a way that an air gap between the armature poles and the pole shoes runs radially to the axis of the armature.

Thus, a construction of the electromagnet is provided which allows a short axial dimension of the electrical pump drive in the pump assembly.

According to one aspect of the invention, the electromagnet and the armature can be arranged in such a way that an air gap between the armature poles and the pole shoes runs axially to the axis of the armature.

Thus, a construction of the electromagnet is provided which allows a slim radial dimension of the electrical pump drive in the pump assembly.

According to one aspect of the invention, a yoke of an electromagnet on which the pole shoes are formed can be configured as a pole ring which is arranged concentrically around the armature or axially to the armature.

An efficient introduction of the magnetic flux density of a magnetic circuit to the armature poles can therefore be realised with a structurally favourable coaxial arrangement of the coil of the electromagnet, as a result of which an electrical pump drive for displacement pumps with small axial dimensions is provided.

According to one aspect of the invention, the electrical pump drive can also comprise a detection device for detecting a position of the armature.

In this way, feedback for regulating a control or power supply of the electrical pump drive for displacement pumps is optionally provided, which can be realised by means of a position sensor or more cheaply still by means of contacts on the working points for detecting at least two armature positions.

According to one aspect of the invention, the electrical pump drive can also comprise a control unit which controls an electrical power supply for an electromagnet in relation to a cycle time and/or in relation to a current polarity of the power that is supplied.

Such control functions can be realised by way of a pulse-width modulator and by way of a bipolar amplifier in the form of standardised electronic components, as a consequence of which it is possible to provide an inexpensive control of an electrical pump drive for displacement pumps. This is particularly true when compared to the power electronics required for a brushless direct current motor, which is customarily used as a pump drive.

According to one aspect of the invention, the electrical pump drive with a rotary solenoid can drive a displacement pump with a pump assembly configured as an oscillating piston pump, the piston of which has two diametrically extending displacement sections which are respectively contained within a sector-shaped working chamber.

In combination with a pump assembly described as an oscillating piston pump or a swinging piston pump, the kinematics of the oscillating piston motion correspond to that of the armature, i.e. the paths of movement can be designed so as to be exactly congruent with each other. This allows a pump construction in which a mechanism between the electrical pump drive and the pump assembly is omitted and a compact integration is achieved by the pivot axle of the armature and the pivot axle of the piston being formed by a shaft.

According to one aspect of the invention, a control method of the electrical pump drive for a displacement pump in the form of the aforementioned oscillating piston pump can comprise switching on and switching off and/or reversing a current polarity of an electrical power supply to the at least one electromagnet as a function of a pre-definable number of cycles of piston movements per unit of time.

With this design, the amplitude of the pivot motion of the armature corresponds to the amplitude of the pivot motion of the piston. Since a displacement pump is concerned, there is also a fixed relationship between a piston stroke and the pumped volumetric flow rate. Thus, using the number of cycles of the piston movement a conclusion can easily be drawn regarding a fixed volumetric flow, or this ratio can be applied to the control specifications of an exact volumetric delivery rate. As a result, a simpler control can be realised as compared with rotary displacement pumps, for example, or a flow meter can be omitted.

According to one aspect of the invention, the control method can also comprise increasing a voltage of the electrical power supply to the at least one electromagnet until it is detected by a detection device that the pivoting motion of the armature reaches the working points.

Thus, a simple control can be realised which determines and supplies the minimum electrical power required on the premise of a predefined volumetric delivery rate.

### BRIEF DESCRIPTION OF THE DRAWINGS

In the following, the invention will be described in detail with reference to the drawings, on the basis of an oscillating piston pump as the exemplary displacement pump equipped with an embodiment of the electrical pump drive. Moreover, further ways of designing the electrical pump drive that are covered by the invention will be described with reference to the drawings based on depictions of various designs of a rotary solenoid. In the drawings:

FIG. 1 shows a cross section through the exemplary oscillating piston pump to illustrate the use of the electrical pump drive as according to the invention;

FIG. 2 shows a longitudinal section through an exemplary oscillating piston pump with an embodiment of the electrical pump drive as according to the invention, which is designed as a twin arrangement of a rotary solenoid comprising two axially adjacent electromagnets and two armature bodies;

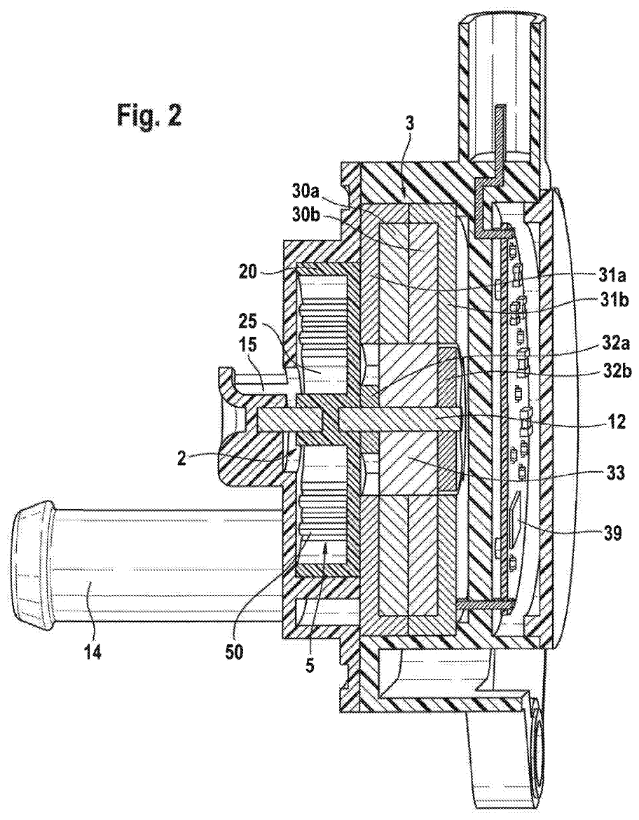

FIG. 3 shows a perspective view of an armature body of the embodiment of the electrical pump drive as according to the invention from a side assigned to the piston;

FIG. 4 shows a perspective view of the other armature body of the embodiment of the electrical pump drive as according to the invention from the opposite side from FIG. 3;

FIG. 5 shows a detailed exploded view to illustrate an alternative way of designing the electrical pump drive as according to the invention; and

FIG. 6 shows a basic exploded view to illustrate another alternative way of designing the electrical pump drive as according to the invention.

### DETAILED DESCRIPTION OF THE INVENTION

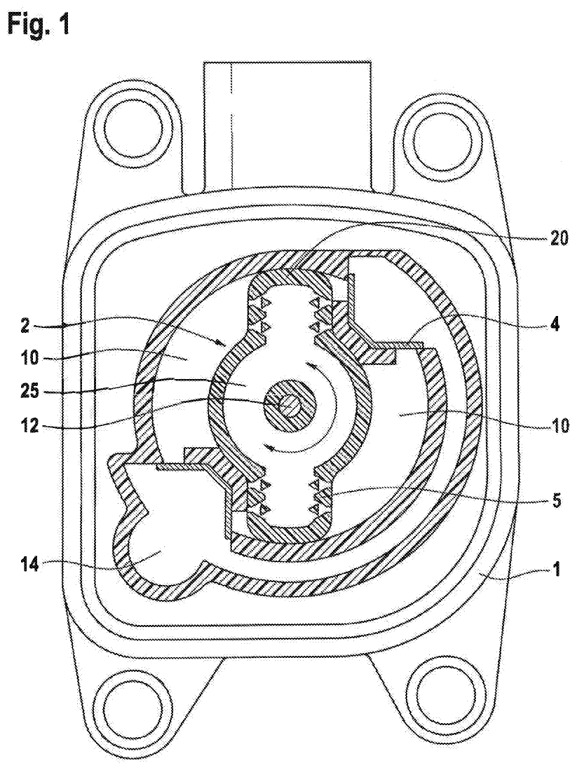

First, the construction of an exemplary oscillating piston pump for use as an oil pump in a low-pressure lubrication system is described with reference to FIG. 1, wherein the pump is equipped with an embodiment of the electrical pump drive as according to the invention. This oscillating piston pump is also the subject matter of a contemporaneous patent application of the same applicant as the present application, and is described in more detail therein.

FIG. 1 shows two diametrically opposed sector-shaped working chambers 10 to the top left and bottom right of a pivot axle 12, which extend in the pump housing 1 in a plane of the pivot motion of the oscillating piston 2. The sides of the working chambers 10 form thrust surfaces for the oscillating piston 2.

Shown to the top right and bottom left of the pivot axle 12, two regions of a pump outlet 14 are arranged between the working chambers 10 and are connected via an arc-shaped channel in the pump housing 1. Clasp-like outlet valves 4 of the oscillating piston pump are formed between the working chambers 10 and the pump outlet 14 in the thrust surfaces of the working chambers 10.

The oscillating piston 2 is fixed onto the pivot axle 12, which is simultaneously a drive shaft of the electrical drive comprising a rotary solenoid 3. The oscillating piston 2 comprises two displacement sections 20 which are pivoted alternately about an angle of rotation of approximately 90° in the working chambers 10, as shown by the double arrow. Inside, the oscillating piston 2 is hollowed out as a hollow body and opened to the side of the viewer of the drawing, as a consequence of which a cavity 25 is formed. The cavity 25 surrounds a mount for the pivot axle 12 and runs into the displacement sections 20.

Disposed in the flanks of the displacement sections 20, which are pivoted towards the thrust surfaces of the working chambers 10, are inlet valves 5 of the oscillating piston pump. The inlet valves 5 allow a delivery flow that has been sucked in via a central pump inlet 15 to pass through the cavity 25 into a working chamber 10, and form a block in the opposite direction from a pump chamber 10 to the cavity 25.

If the oscillating piston 2 moves anti-clockwise from the starting position shown in FIG. 1, a volume of the conveyed medium is displaced or pushed out of the working chambers 10 upstream of the oscillating piston 2. In this case the outlet valves 4 on the pressure side of the oscillating piston 2 in the pump housing 1 are opened towards the pump outlet 14, while the inlet valves 5 on the front pressure side of the oscillating piston 2 block the passage to the cavity 25.

At the same time, a vacuum is formed in the section of the working chamber 10 on the rear side of the oscillating piston 2, such that a volume of the conveyed medium sucked in via the pump inlet 15 flows into the working chamber 10. Here, the inlet valves 5 on the rear suction side of the oscillating piston 2 are opened by the sucked in delivery flow and the conveyed medium in the cavity 25 flows through said valves to the working chamber 10, while the outlet valves 4 block the pump chamber 10 to the pump outlet 14. The same functionality occurs in a reversed pivot motion back into the starting position of the oscillating piston 2 in FIG. 1. The oscillating piston pump is therefore a type of double-action pump.

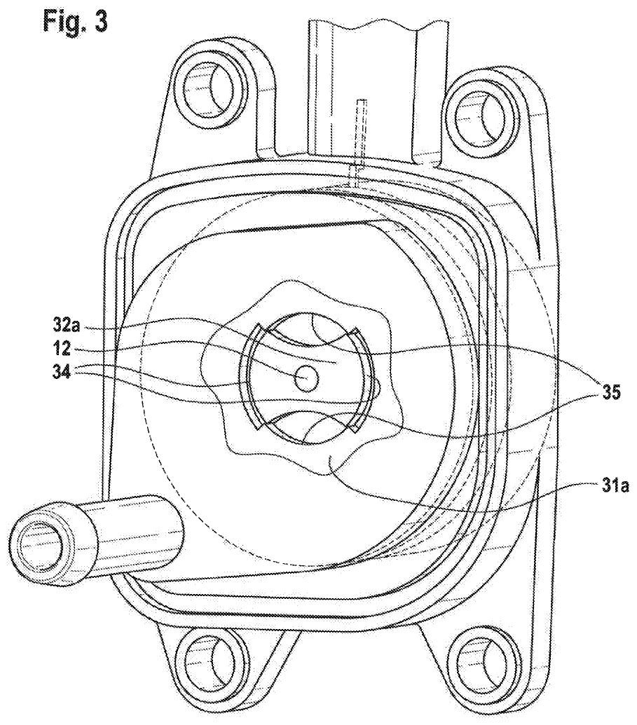

As is shown in FIG. 3, the pump housing 1 further comprises a flange portion aligned in the direction of the working chambers 10, in which an embodiment of the electrical drive comprising a rotary solenoid 3 is accommodated. On the side of the pump housing 1 shown on the right, a further flange portion closed by a cover is formed, in which a control circuit 39 of the electrical drive 3 is accommodated. Supply line connections which lead to electromagnets 30 of the rotary solenoid 3 exit the pump housing 1 through a connecting piece shown directed upward.

The electrical drive shown is configured as a twin arrangement of a rotary solenoid 3 comprising two axially adjacent electromagnets 30a, 30b and two armature bodies 32a, 32b, and therefore forms a so-called type of bistable rotary solenoid 3.

The ring-shaped electromagnets 30a, 30b are separated axially from one another and are in contact with two pole rings 31a, 31b which are also axially separated and which form a one-sided pole system with flux return via a common ferrite core 33 or yoke. The pivot axle 12 on which the armature 32 is arranged such that it can pivot is mounted in the ferrite core 33. The armature 32 comprises two armature bodies 32a, 32b which each have a diametrically longer extension and, at 90° thereto, a diametrically shorter extension in the radial direction.

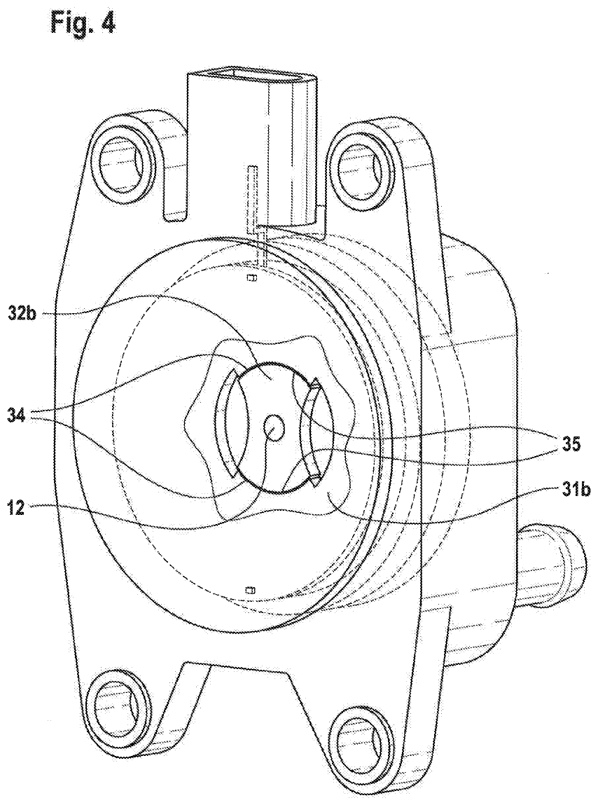

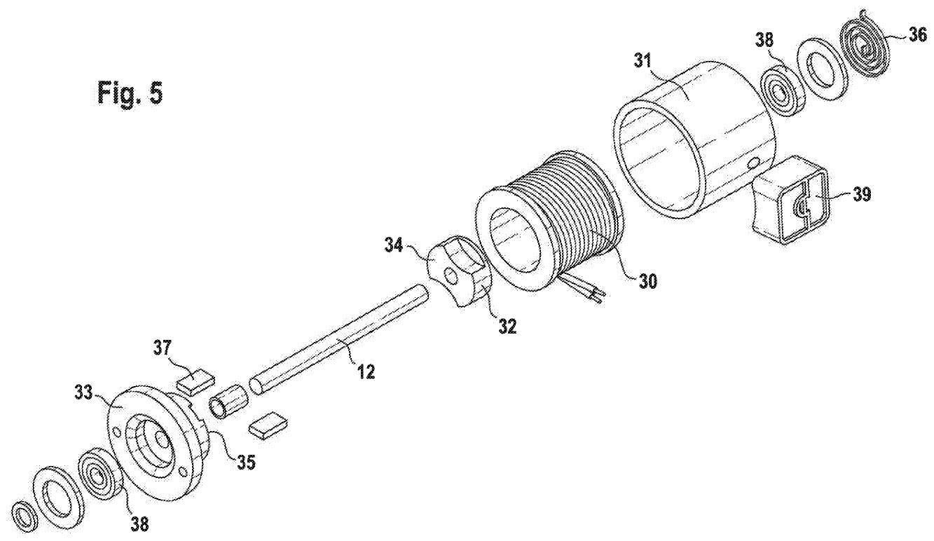

As is clear from FIG. 4 and FIG. 5, the armature bodies 32a, 32b have the contour of a circular surface in which two opposite inwardly recessed circular arc segments are formed. The sections between the recesses which have the greater diametrical extension in the radial direction form radially outwardly pronounced armature poles 34. The armature bodies 32a, 32b are each held in a central recess of a pole ring 31a, 31b such that they can pivot together. The recesses of the pole rings 31a, 31b comprise two opposite radially inwardly pronounced pole shoes 35. The two armature bodies 32a, 32b, i.e. in particular the armature poles 34 thereof, are arranged at 90° to one another. Alternatively, however, the pole shoes 35 of the two pole rings 31a, 31b can also be configured so as to be at 90° to one another.

This results in the following mode of operation of the embodiment of the pump drive according to the invention depicted herein. When an electromagnet 30a is supplied with power, the armature 32 pivots by way of the reluctance force into a position in which the corresponding armature body 32a aligns itself with the armature poles 34 to the pole shoes 35 of the recess in the corresponding pole ring 31a in order to reduce the air gap and therefore the magnetic reluctance in a magnetic circuit that is generated by the electromagnet 30a in the pole ring 31a, the armature body 32a and in the flux return via the ferrite core 33.

When the two electromagnets 30a, 30b are alternately supplied with power by the control circuit 39, the offset arrangement of the armature poles 34 and the pole shoes 35 generates an alternating pivot motion of the pivot axle 12 by 90°, as a result of which the oscillating piston 2 is driven in the aforementioned mode of operation of the oscillating piston pump.

In more general terms, the principle of a rotary solenoid 3 of this embodiment corresponds to the following procedural steps: exciting the first electromagnet 30a with the electrical power supply such that the armature 32 is pivoted by a magnetic field of the first electromagnet 30a from the first working point to the second working point; and exciting the second electromagnet 30b with the electrical power supply such that the armature 32 is pivoted by a magnetic field of the second electromagnet 30b from the second working point to the first working point.

As is shown in FIG. 5 as an exploded view, a further way of realising another embodiment of the electrical pump drive as according to the invention consists in the design of a rotary solenoid 3, known from the prior art, comprising just one electromagnet 30 and a spiral-shaped return spring 36. This design, which is presented as an alternative variant of the rotary solenoid 3 of the electrical pump drive, also has stop elements 37 as mechanical limitation means and ball bearings 38 for independently supporting the pivot axle 12 inside the electrical pump drive, a switch for the power supply as a component of the control circuit 39 and other small parts such as a spacer sleeve, a retaining ring and the like. The armature poles 34 of the armature 32 are axially pronounced and are assigned corresponding axially pronounced pole shoes 35 on a ferrite core board 33 as the yoke, which establishes a return path via the pivot axle 12 and a spring cage from the magnetic circuit to the pole ring 31, which is generated by the electromagnet 30.

As is revealed by the illustration in FIG. 5, such a possible embodiment of the electrical pump drive has the following mode of operation. When the electromagnet 30 is excited with an electrical power supply by the switch of the control circuit 39, the armature 32 pivots by way of the reluctance force from a first working point to a second working point at which the armature poles 34 overlap the pole shoes 35 and reduce the air gap of the magnetic circuit. In doing so the armature 32 hits the stop elements 37 and is stopped at the second working point. During the pivot motion the return spring 36 which is fixed between the armature 32 and the pole ring 31 is pretensioned at the same time. Once the excitation of the electromagnet 30, which generates a holding torque against the stop, has ended, the armature 32 is pivoted back by the return spring 36 from the second working point to the first working point until it is stopped at the stop elements 37. Thus, such a design of the electrical pump drive as according to the invention drives the oscillating piston 2 in the mode of operation of the oscillating piston pump as described above.

In more general terms, the principle of a rotary solenoid 3 of this possible design corresponds to the following procedural steps: exciting the electromagnet with the electrical power supply such that the armature 32 is pivoted by a magnetic field of the electromagnet 30 from the first working point to the second working point; and interrupting the excitement of the electromagnet 30 with the electrical power supply such that the armature 32 is pivoted by the restoring force of the pretensioned return spring 36 from the second working point to the first working point.

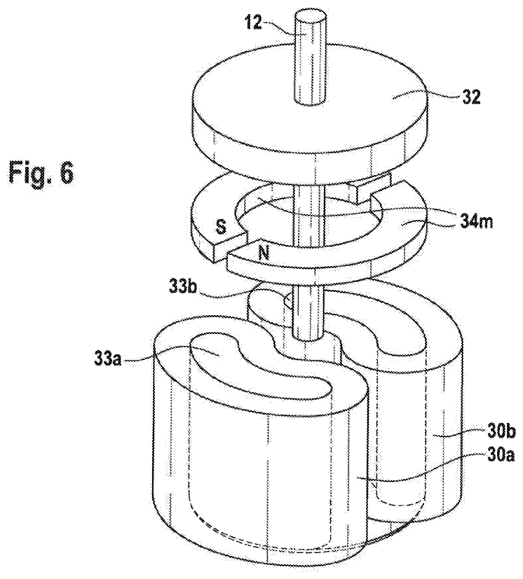

A further way of realising another embodiment of the electrical pump drive according to the invention based on a design of a rotary solenoid 3 known from the prior art is shown in FIG. 6. Like the first embodiment described above, this rotary solenoid 3 comprises a two-pole excitation coil or two electromagnets 30a, 30b arranged in the form of kidney-shaped windings on both sides of the pivot axle 12, each having a ferrite core 33a, 33b or yoke. Axially adjacent to the electromagnets 30a, 30b, a disc-shaped armature 32 is arranged on the pivot axle 32, which carries two semicircular permanent magnets 34m as the armature poles 34. The permanent magnets 34m are magnetised in the longitudinal extension thereof and are applied to the armature 32 in the opposite direction. The polarisation limit lies symmetrically above the poles of the electromagnets 30a, 30b. The transition region between the poles N/S contributes substantially to the transmission of force.

The mode of operation is similar to that of a permanently excited electric motor and follows the electrodynamics between the electrical power supply and the resulting magnetic polarities. When the electromagnets 30, 30b are excited, the armature 32 experiences a deflecting torque, wherein the direction of rotation is determined by the polarity of the electromagnets 30a, 30b. By alternately exciting and interrupting each electromagnet 30a, 30b or by alternate excitation with alternating polarity, the armature 32 is pivoted back and forth between two working points which are preferably defined by mechanical limits. Thus, such a design of the electrical pump drive as according to the invention drives the oscillating piston 2 in the mode of operation of the oscillating piston pump as described above.

Moreover, in this regard a variant is conceivable in which just one electromagnet 30 is arranged, which exerts a corresponding magnetic field with alternating polarity upon the armature 32 by the electrical power supply with alternating current polarity.

In more general terms, the principle of a rotary solenoid 3 of this possible design corresponds to the following procedural steps: exciting the electromagnet 30 or the electromagnets 30a, 30b with the electrical power supply such that the armature 32 is pivoted by a magnetic field of the electromagnet 30a, 30b from the first working point to the second working point; and exciting the electromagnet 30 or the electromagnets 30a, 30b with the electrical power supply with reversed current polarity such that the armature 32 is pivoted by the reversed magnetic field of the electromagnet 30 or the electromagnets 30a, 30b from the second working point to the first working point.

It is true of all of the embodiments of the rotary solenoid 3 that have been shown and described that with a higher number of poles the angle of rotation decreases and the torque generated increases.

Moreover, it is understood that the pump drive according to the invention can be used with different pump assemblies of displacement pump types from the oscillating piston pump described. With a mechanically modified drive connection the pump drive according to the invention can also be used in displacement pumps in which a linear reciprocating piston movement is performed, as in the case of a cylindrical pump chamber, for example. In this case pump assemblies with a piston acting bidirectionally as well as those with, for example, two separately articulated pistons and designs with or without the double stroke principle are suitable for the pump drive according to the invention.

1. An electrical pump drive for displacement pumps with pistons moved in an oscillating manner; wherein
the electrical pump drive comprises a rotary solenoid which has at least one electromagnet and an armature that can be pivoted about an axis, which armature can be pivoted alternately between two working points by exciting the at least one electromagnet; wherein
the armature is adapted to couple with a piston moved in an oscillating manner.

2. The electrical pump drive according to claim 1, wherein an electromagnet of the rotary solenoid is able to be excited by an alternating current polarity for the alternating pivoting motion of the armature.

3. The electrical pump drive according to claim 1, wherein the rotary solenoid furthermore has a return spring for the armature, and the electromagnet is able to be excited for the pivoting motion of the armature against a restoring force of the return spring.

4. The electrical pump drive according to claim 1, wherein the rotary solenoid has at least two electromagnets, and the at least two electromagnets are able to be excited alternately for the alternating pivoting motion of the armature.

5. The electrical pump drive according to claim 2, wherein the armature comprises at least one permanent magnet.

6. The electrical pump drive according to claim 3, wherein the armature comprises a ferromagnetic armature body with pronounced armature poles, and the armature poles are assigned to pole shoes disposed stationarily at a working point of the armature.

7. The electrical pump drive according to claim 3, wherein the armature comprises an armature body with ferromagnetic armature poles which have greater magnetic permeability than other sections of the armature body, and the armature poles are assigned to pole shoes disposed stationarily at a working point of the armature.

8. The electrical pump drive according to claim 6, wherein the electromagnet and the armature are positioned such that an air gap between the armature poles and the pole shoes runs radially to the axis of the armature.

9. The electrical pump drive according to claim 6, wherein the electromagnet and the armature are arranged such that an air gap between the armature poles and the pole shoes runs axially to the axis of the armature.

10. The electrical pump drive according to claim 9, wherein a yoke of an electromagnet, on which the pole shoes are formed, is configured as a pole ring which is arranged concentrically around the armature.

11. The electrical pump drive according to claim 1, wherein the rotary solenoid has limitation means which limit a pivoting motion of the armature at the two working points.

12. The electrical pump drive according to claim 1, further having a detection device for detecting a position of the armature.

13. The electrical pump drive according to claim 1, further having a control unit which controls an electrical power supply for an electromagnet in relation to a cycle time and/or in relation to a current polarity of the power that is supplied.

14. Use of the electrical pump drive with a rotary solenoid according to claim 1 for driving a displacement pump with a piston moved in an oscillating manner between two turning points.

15. A displacement pump for gaseous and liquid fluids, having:
a pump assembly with a working chamber, an inlet, an outlet and a piston which is moved in an oscillating manner in the working chamber between two turning points, wherein
an electrical pump drive comprises a rotary solenoid which has at least one electromagnet and an armature that can be pivoted about an axis, which armature can be pivoted alternately between two working points by exciting the at least one electromagnet; wherein
the armature is coupled with the piston such that the turning points of the oscillating motion of the piston are reached at the working points of the armature.

16. The displacement pump according to claim 15, wherein the pump assembly is configured as an oscillating piston pump, the piston of which has two diametrically extending displacement sections which are respectively contained within a sector-shaped working chamber.

17. A method for moving a piston of a displacement pump in an oscillating manner between two turning points by means of a rotary solenoid, wherein:
the rotary solenoid has at least one electromagnet and an armature that can be pivoted about an axis, which armature can be pivoted alternately between two working points by exciting the at least one electromagnet; and
the armature is coupled with the piston such that the turning points of the oscillating motion of the piston are reached at the working points of the armature;
wherein the method includes:
generating a magnetic field by means of an electromagnet, wherein the magnetic field exerts a torque upon the armature in a pivoting direction until the piston reaches a turning point; and
interrupting the generation of the magnetic field by the electromagnet and/or generating a magnetic field of opposite polarity by means of an electromagnet, wherein the magnetic field of opposite polarity exerts a torque upon the armature in the opposite pivoting direction until the piston reaches the other turning point.

18. A control method for a displacement pump for gaseous and liquid fluids according to claim 15, with the step:
switching on and switching off and/or reversing a current polarity of an electrical power supply to the at least one electromagnet as a function of a pre-definable number of cycles of piston movements per unit of time.

19. The control method according to claim 18, wherein
the electrical pump drive of the displacement pump further comprises a detection device for detecting a position of the armature; also including the step:
increasing a voltage of the electrical power supply to the at least one electromagnet until it is detected by the detection device that the pivoting motion of the armature reaches to the working points.
